(19) United States
(12) Patent Application Publication
(10) Pub. No.: US 2009/0070626 A1
(43) Pub. Date: Mar. 12, 2009

(54) METHODS AND SYSTEMS FOR OPERATING SYSTEM BARE-METAL RECOVERY

(76) Inventors: Rick Shengli Chen, Beijing (CN); Pujun Wu, Beijing (CN); Pratap Karonde, Islandia, NY (US)

Correspondence Address: SCHWEGMAN, LUNDBERG & WOESSNER, P.A., P.O. BOX 2938, MINNEAPOLIS, MN, 55402, US

(21) Appl. No.: 11/853,552

(22) Filed: Sep. 11, 2007

(51) Int. Cl. G06F 11/14

(52) U.S. Cl. 714/7; 714/E11.122

(57) ABSTRACT

A system and method of recovering a system on replacement hardware includes booting the replacement hardware from an operating system disk. A recovery media is coupled to the replacement hardware to provide access to system information for restoring programming to replacement hardware. A specific file is provided on the recovery media that is looked for during the booting of the replacement hardware. When the specific file is found, recovery specific system information is loaded onto the replacement hardware to facilitate a recovery process.

### BACKGROUND

Computer systems in many business settings are backed up periodically. A disaster can destroy hardware used in the computer systems. Such hardware is usually replaced, and the operating system, system settings, applications and data are restored to one of the backed up states. Such a restoration may commonly be referred to as a bare metal recovery solution. It is based on the concept of collecting and saving machine-specific information before the disaster strikes. Prior solutions to recovering from bare metal involve burning a specific preinstallation environment media that includes the operating system. Licenses may be required in order to burn and distribute such media, adding cost to the recovery process.

### SUMMARY

In one embodiment, a method creates a recovery media for a computer system that includes system information for restoring programming to replacement hardware. The replacement hardware is booted from an operating system disk and the recovery media is coupled to the replacement hardware to provide access to the recovery media. A specific file is provided on the recovery media that is looked for during the booting of the replacement hardware. When the specific file is found, recovery specific information is loaded onto the replacement hardware to facilitate a recovery process.

In a further embodiment, a method recovers a system on replacement hardware. The method comprises booting the replacement hardware from an operating system disk and coupling a recovery media to the replacement hardware to provide access to system information for restoring programming to replacement hardware. A specific file is provided on the recovery media that is looked for during the booting of the replacement hardware. When the specific file is found, loading recovery specific system information onto the replacement hardware to facilitate a recovery process.

In a further embodiment, a method backs up data for a computer system. The method comprises creating a recovery media for hardware in the computer system that includes system information to facilitate restoration of programming and data to replacement hardware when hardware of the computer is replaced, wherein a specific file is provided on the recovery media that is looked for during the booting of the replacement hardware from the operating system disk, and wherein when the specific file is found during such booting, loading recovery specific information onto the replacement hardware to facilitate a recovery process that includes restoring the backed up data to recover the computer system to a known state.

In yet a further embodiment, a computer readable recovery media has instructions for causing a computer to implement a method of recovering a system on replacement hardware when the recovery media is coupled to the replacement hardware. The method comprises providing a specific file on the recovery media that is looked for during the booting of the replacement hardware from an operating system disk; and when the specific file is found, loading recovery specific system information onto the replacement hardware to facilitate a recovery process.

In a further embodiment, a computer system comprises replacement hardware and a recovery media that includes system information to facilitate restoration of programming and data to the replacement hardware, wherein a specific file is provided on the recovery media that is looked for during booting of the replacement hardware from an operating system disk, and wherein when the specific file is found during such booting, recovery specific information is loaded onto the replacement hardware to facilitate a recovery process that includes restoring backed up data to recover the computer system to a known state.

### BRIEF DESCRIPTION OF THE DRAWINGS

FIG. 1 is a flow chart illustrating a media and method of initiating recovery of bare metal hardware according to an example embodiment.

FIG. 2 is a block diagram of an example system that utilizes the media and method of FIG. 1.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein are implemented in software or a combination of software and human implemented procedures in one embodiment. The software may consist of computer executable instructions stored on computer readable media such as memory or other type of storage devices. The term “computer readable media” is also used to represent any means by which the computer readable instructions may be received by the computer, such as by different forms of wireless transmissions. Further, such functions correspond to modules, which are software, hardware, firmware or any combination thereof. Multiple functions are performed in one or more modules as desired, and the embodiments described are merely examples. The software is executed on a digital signal processor, ASIC, microprocessor, or other type of processor operating on a computer system, such as a personal computer, server or other computer system.

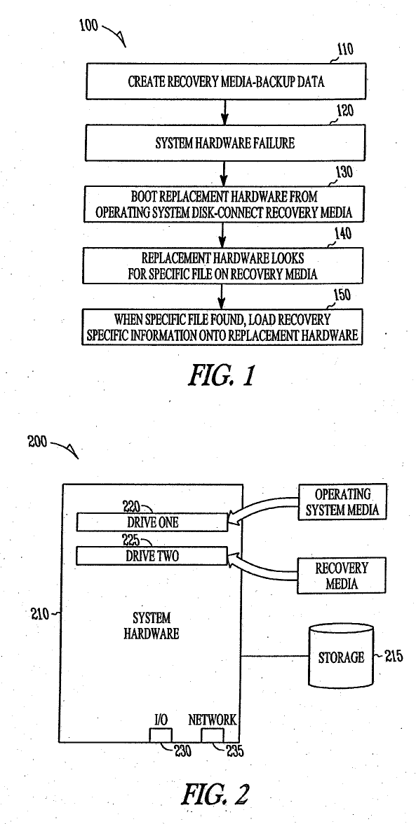

FIG. 1 is a flowchart illustrating a method 100 of recovery of a system when hardware is replaced, such as due to a disaster, maintenance, upgrade, etc. During normal operation of the system, backups of data occur at scheduled or other selected times as indicated at 110. Recovery media may also be created, and contains information that can help restore bare hardware that may be replaced.

At 120, a hardware failure or other need exists for replacing the hardware. At 130, the hardware is booted from an operating system disk. An operating system disk may be one or more disks having code used to load the operating system onto bare metal hardware in one embodiment. In further embodiments, operating system installation files may be stored on the hardware, such as in .cab files. The execution of such code by the hardware is referred to as a boot process. During the boot process, a specific file may be looked for at 140 on one or more drives. Such a file is provided on the recovery media and is coupled to the hardware prior to the point of booting where such file is looked for. This may occur at approximately the same time as insertion or booting from the operating system disk occurs as indicated at 130.

At 150, when the specific file is found, recovery specific information may be loaded onto the replacement hardware in a pre-installation environment. In one embodiment, the specific information facilitates a recovery process. In different embodiments, the specific information may include one or more of disaster recovery specific binaries, disk partitioning information, device initialization information, and network initialization information. Once the specific information is loaded, a backup of the data may be performed and the boot process may also continue from the operating system disk if desired. In further embodiments, other applications that need to run in a pre-installation environment may be launched.

In one embodiment, the recovery media is stored on a USB memory stick, a floppy disk, or other media that can be accessed by the system via a USB port or floppy disk drive.

In a further embodiment, a method of recovering a system on replacement hardware includes booting the replacement hardware from an operating system disk and coupling a recovery media to the replacement hardware at 130 to provide access to system information for restoring programming to replacement hardware. The system information may reside on other storage devices local or remote from the hardware.

A specific file is stored on the recovery media that is looked for during the booting of the replacement hardware at 140. At 150, when the specific file is found, recovery specific system information is loaded onto the replacement hardware to facilitate the recovery process. In one embodiment, the recovery specific system information includes network initialization information including an IP address.

In one embodiment, the operating system disk is a retail version, or other licensed version, of Microsoft Vista™/Windows Server 2008 installation media. The name of the specific file is unattend.xml.

In yet a further embodiment, a method includes backing up data for a computer system and creating a recovery media for hardware in the computer system that includes system recovery specific information to facilitate restoration of programming and data to replacement hardware when hardware of the computer is replaced. The method also includes booting the replacement hardware from an operating system disk and coupling the recovery media to the replacement hardware to provide access to the recovery media that includes a specific file that is looked for during the booting of the replacement hardware from the operating system disk. When the specific file is found, in such embodiments, the method includes loading recovery specific information onto the replacement hardware to facilitate a recovery process that includes restoring the backed up data to recover the computer system to a known state.

FIG. 2 is a block diagram of an example computer system 200 on which the methods of FIG. 1 may be executed. System 200, in one embodiment, includes hardware 210 such as a general computing device in the form of a computer. Hardware 210 may be coupled to storage device 215 and may contain multiple storage devices, 220 and 225, which respectively in one embodiment are a storage device or drive and a USB memory device or port for attaching a USB memory device. Hardware 210, may include a processing unit, and memory. Memory may include volatile memory and non-volatile memory such as random access memory (RAM), read only memory (ROM), erasable programmable read-only memory (EPROM) & electrically erasable programmable read-only memory (EEPROM), flash memory or other memory technologies. Storage devices 220 and 225 may include compact disc read-only memory (CD ROM), Digital Versatile Disks (DVD) or other optical disk storage, magnetic cassettes, magnetic tape, magnetic disk storage such as floppy or hard, or other magnetic storage devices, or any other local or networked medium capable of storing computer-readable instructions and accessible to the system 200.

Hardware 210 may include or have access to a computing environment that includes input/output devices 230, and a communication connection 235. The hardware 210 may operate in a networked environment using a communication connection to connect to one or more remote computers. The remote computer may include a personal computer (PC), server, router, network PC, a peer device or other common network node, or the like. The communication connection may include one or more of a Local Area Network (LAN), a Wide Area Network (WAN), the Internet, or other networks.

Computer-readable instructions stored on a computer-readable medium are executable by the hardware 210. A hard drive, floppy drive, USB memory stick, memory cards, CD-ROM, and RAM are some examples of articles including a computer-readable medium.

In a further embodiment, the bare metal hardware may be configured to connect to a network and boot from a network copy of the operating system. The recovery media may then be used as above to configure the hardware during the boot process. In one embodiment, a first file may be provided on hardware memory or the recovery media that is executable within a basic input/output system (BIOS) environment of the system 200. The first file, when executed, causes one or more device initialization processes to be executed. In some embodiments, one of the device initialization processes is a process to initialize a network interface to enable network communications on the system 200. The first file may then further execute to access an operating system disk from which an operating system installation program may be executed. The first file, when further executed, may also provide data to the operating system installation program to cause the operating system to load data from one or more of the backup files. In some such embodiments, the first file, when executed, causes one or more files to be copied from a network storage location where the one or more files are stored to the storage 215 of the system 200.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

1. A method comprising:
creating a recovery media for a computer system that includes system information for restoring programming to replacement hardware;
booting the replacement hardware from an operating system disk and coupling the recovery media to the replacement hardware to provide access to the recovery media;
providing a specific file on the recovery media that is looked for during the booting of the replacement hardware; and
when the specific file is found, loading recovery specific information onto the replacement hardware to facilitate a recovery process.

2. The method of claim 1 and further comprising continuing to boot from the operating system disk following the loading of recovery specific information onto the replacement hardware.

3. The method of claim 1 wherein the recovery specific system information includes information selected from the group consisting of disaster recovery specific binaries, disk partitioning information, device initialization information, and network initialization information.

4. The method of claim 1 wherein access to the recovery media is provided via a USB port or floppy disk drive.

5. A method of recovering a system on replacement hardware, the method comprising:
booting the replacement hardware from an operating system disk and coupling a recovery media to the replacement hardware to provide access to system information for restoring programming to replacement hardware;
providing a specific file on the recovery media that is looked for during the booting of the replacement hardware; and
when the specific file is found, loading recovery specific system information onto the replacement hardware to facilitate a recovery process.

6. The method of claim 5 wherein the recovery specific system information includes disaster recovery specific binaries.

7. The method of claim 5 wherein the recovery specific system information includes disk partitioning information.

8. The method of claim 5 wherein the recovery specific system information includes device initialization information.

9. The method of claim 5 wherein the recovery specific system information includes network initialization information including an IP address.

10. The method of claim 5 wherein access to the recovery media is provided via a USB port or floppy disk drive.

11. The method of claim 5 and further comprising executing a recovery process after specific system information has been loaded.

12. The method of claim 5 and further comprising restoring data to storage devices after specific system information has been loaded.

13. The method of claim 5 wherein the operating system disk is a Vista™/Windows Server 2008 installation media.

14. The method of claim 13 wherein the name of the specific file is unattend.xml.

15. A method comprising:
backing up data for a computer system;
creating a recovery media for hardware in the computer system that includes system information to facilitate restoration of programming and data to replacement hardware when hardware of the computer is replaced, wherein a specific file is provided on the recovery media that is looked for during the booting of the replacement hardware from the operating system disk, and wherein when the specific file is found during such booting, loading recovery specific information onto the replacement hardware to facilitate a recovery process that includes restoring the backed up data to recover the computer system to a known state.

16. The method of claim 15 wherein the recovery specific system information includes information selected from the group consisting of disaster recovery specific binaries, disk partitioning information, device initialization information, and network initialization information.

17. The method of claim 15 wherein access to the recovery media is provided via a USB port or floppy disk drive.

18. The method of claim 15 and further comprising executing a recovery process after specific system information has been loaded that includes restoring data to storage devices.

19. The method of claim 15 wherein the operating system disk is a Vista™/Windows Server 2008 installation media and the name of the specific file is unattend.xml.

20. A computer readable recovery media having instructions for causing a computer to implement a method of recovering a system on replacement hardware when the recovery media is coupled to the replacement hardware, the method comprising:
providing a specific file on the recovery media that is looked for during the booting of the replacement hardware from an operating system disk; and
when the specific file is found, loading recovery specific system information onto the replacement hardware to facilitate a recovery process.

21. A computer system comprising:
replacement hardware; and
a recovery media that includes system information to facilitate restoration of programming and data to the replacement hardware, wherein a specific file is provided on the recovery media that is looked for during booting of the replacement hardware from an operating system disk, and wherein when the specific file is found during such booting, recovery specific information is loaded onto the replacement hardware to facilitate a recovery process that includes restoring backed up data to recover the computer system to a known state.

22. The computer system of claim 21 and further comprising operating system installation files stored on the replacement hardware.
